(19) United States
(12) Patent Application Publication
(10) Pub. No.: US 2011/0043060 A1
(43) Pub. Date: Feb. 24, 2011

(54) Interference suppressor for suppressing high-frequency interference emissions from a direct current motor that is drivable in a plurality of stages and/or directions

(76) Inventors: Claus Schmiederer, Rheinau-Freistett (DE); Michael Haerer, Buehlertal (DE); Tobias Kuechen, Emmendingen (DE)

Correspondence Address: STRIKER, STRIKER & STENBY, 103 East Neck Road, Huntington, NY, 11743, US

(21) Appl. No.: 12/894,784

(22) Filed: Sep. 30, 2010

Related U.S. Application Data
(63) Continuation of application No. 10/591,890, filed on Sep. 7, 2006.

(30) Foreign Application Priority Data
Nov. 19, 2004 (DE) 102004056041.2

(51) Int. Cl. H02K 11/02

(52) U.S. Cl. 310/72

(57) ABSTRACT

An interference suppressor for suppressing high-frequency interference emissions of a direct current motor that is drivable in a plurality of stages and/or directions, comprising a plurality of capacitors located on a first side of a printed circuit board, a plurality of first conductor tracks located on the first side of the printed circuit board for putting the capacitors into contact with a ground terminal, a first terminal and at least one further terminal provided for individual stages of the direct current motor, and put into contact with a first connection line for a first stage and at least one second connection line for at least one second stage of the direct current motor, a ground face located on a second side, diametrically opposite the first side of the printed circuit board, with the first connection line and the at least one second connection line fed through in insulated fashion relative to the ground face wherein the ground face is electrically connected via through-plated holes embodied as via-holes to the ground terminals of the capacitors on the first side of the printed circuit board, and wherein the capacitors are arranged in at least one group, in which the capacitors are located in a C-shaped arrangement.

### CROSS-REFERENCE TO RELATED APPLICATION

This application is a continuation of patent application Ser. No. 10/591,890 filed on Sep. 7, 2006, whose subject matter is incorporated here by reference, provides the basis for a claim of priority of invention under 35 U.S.C. 119(a)-(d).

This application also is based on German Patent Application DE 10 2004 056 041.2 filed on Nov. 19, 2004. This German Patent Application, whose subject matter is incorporated here by reference, provides the basis for a claim of priority of invention under 35 U.S.C. 119(a)-(d).

### BACKGROUND OF THE INVENTION

The invention relates to an interference suppressor for suppressing high-frequency interference emissions from a direct current motor that is drivable in a plurality of stages and/or directions, as generically defined by the independent claim.

For commutation (current inversion) of direct current motors, both electrical provisions, such as using a power end stage constructed with transistors, and mechanical provisions are known. Among the mechanical provisions is the use of a commutator in conjunction with conductive brush elements, and the commutator has individual commutator laminations. Typically, it is provided that relative to the commutator rotating about a pivot axis, the brush elements are stationary, in such a way that during the rotation of the commutator, the brush elements sweep over the various commutator laminations in sequential order. As a result of the contact of the brush element with a commutator lamination, an electrical conductive connection is created, through which the operating current of the direct current motor flows. At the transition of a brush element from one commutator lamination to the next, gas discharges occur, which engender very steep current spikes. These current spikes lead in turn to high-frequency interference emissions, which manifest themselves both in electrical pulses along the current-carrying elements of the direct current motor and in electromagnetic radiation (interfering radiation).

From German Patent Disclosure DE 101 29 884 A1, it is known to use a printed circuit board, which as a shield reduces the interference emissions emitted by the direct current motor. It is also known in the prior art, for further suppressing the high-frequency interference emissions, to use ceramic capacitors located on the printed circuit board.

### SUMMARY OF THE INVENTION

It is therefore an object of the present invention to provide an interference suppressor which is a further improvement of the existing interference suppressors.

In keeping with these objects and with others which will become apparent hereinafter, the present invention resides in an interference suppressor for suppressing high-frequency interference emissions of a direct current motor that is drivable in a plurality of stages and/or directions, having a plurality of capacitors located on a first side of a printed circuit board and having a plurality of first conductor tracks, located on the first side of the printed circuit board, for putting the various capacitors into contact with a ground terminal and having a first terminal and at least one further terminal for the individual stages of the direct current motor, the first terminal and the at least one further terminal being put into contact with a first connection line for the first stage and at least one further connection line for the at least one further stage of the direct current motor which offers a considerable improvement in efficiency in interference suppression technology by means of an optimized-impedance ground connection and a direct motor terminal contact, if a ground face is located on a further side, diametrically opposite the first side, of the printed circuit board, and the first connection line and the at least one further connection line are fed through in insulated fashion relative to the ground face. In this way, a very compact, economical structural form of the interference suppressor can be implemented. Moreover, interrupting the connection lines to the direct current motor, which could in turn lead to increased interference emissions at the interruption point, is unnecessary.

In accordance with another important feature of the present invention, the capacitors are arranged in at least one group in which the capacitors are located in a C-shaped arrangement.

In accordance with still a further feature of the present invention, the capacitors are arranged in two groups so that in each of the groups the capacitors are arranged in a C-shaped arrangement and surround a respective one of the first terminal and the further terminal.

In accordance with a further feature of the present invention, the capacitors of one of the groups surround one of the terminals while the capacitors of the other of the groups surround the other of the terminals so that interiors of the C-shaped arrangements of the capacitors face each other.

In accordance with another feature of the present invention the groups of the capacitor includes four capacitors, wherein the wire-holes are located at open ends of each of the C-shaped arrangements of the capacitors and at an apex point of each of the C-shaped arrangements of the capacitors.

In accordance with still a further feature of the present invention the wire-holes are electrically conductive sleeves which are filled with a highly-conductive metal.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows an exemplary embodiment of a first side of a printed circuit board of the interference suppressor of the invention;

FIG. 2 shows an exemplary embodiment of a further side of a printed circuit board of the interference suppressor of the invention;

FIG. 3 shows an exemplary embodiment of an electrical connection between the interference suppressor of the invention and a direct current motor; and

FIG. 4 is a block circuit diagram of the interference suppressor of the invention.

### DESCRIPTION OF THE PREFERRED EMBODIMENTS

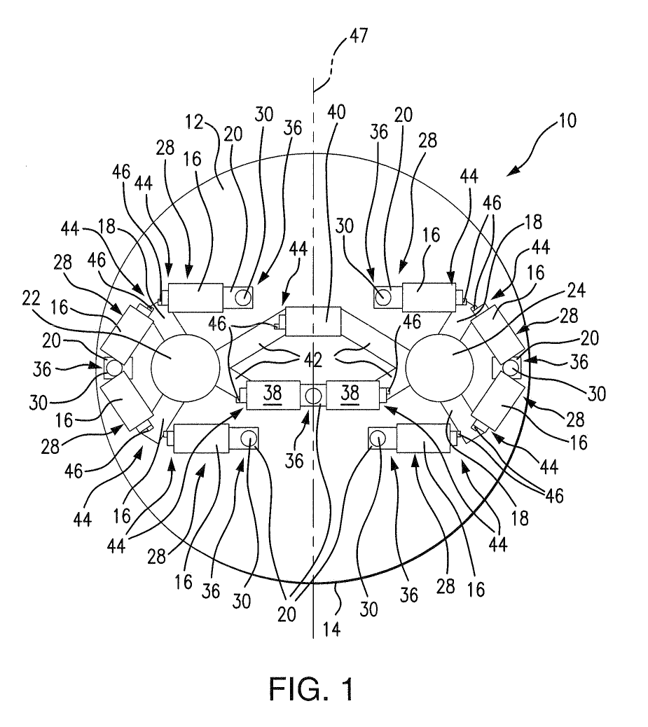

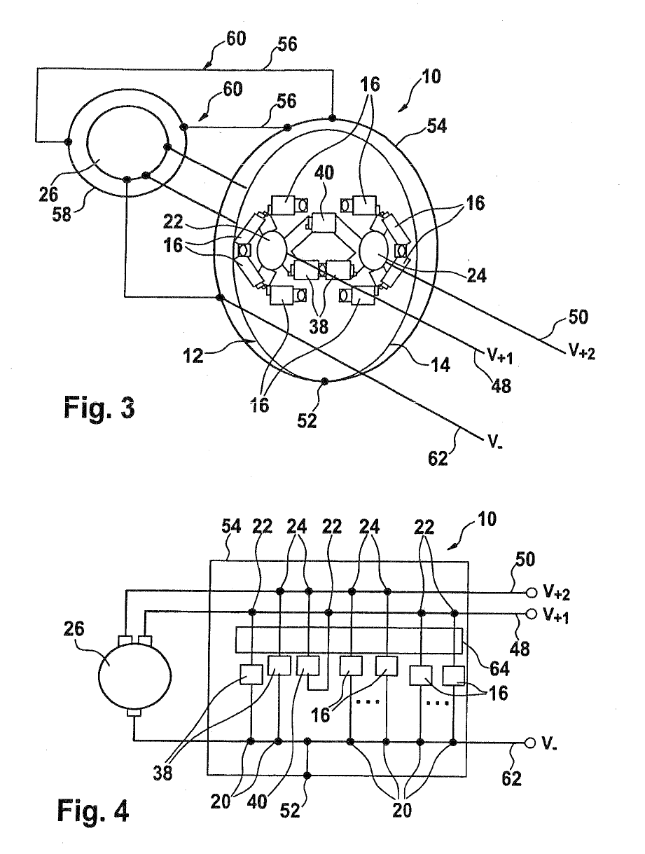

In FIG. 1, an exemplary embodiment of a first side 12 of a printed circuit board 14 of the interference suppressor 10 of the invention is shown; the first side 12 defines the front or top side of the printed circuit board 14. A plurality of capacitors 16 (eight of them in the exemplary embodiment shown) are located on the printed circuit board 14 and are each put into contact via respective first conductor tracks 18 with a ground terminal 20 and a first terminal 22 and at least one further terminal 24 for the individual stages of a direct current motor 26, shown in FIGS. 3 and 4. SMD (surface mounted device) ceramic capacitors 28, which because of their low structural height make a very compact structure of the interference suppressor 10 possible, are for instance used as the capacitors 16. Conversely, if reducing expenses is primary, then at least some of the capacitors 16 can be contacted via radial or axial connection wires extended to the outside. Depending on the filter requirements, the capacitors 16 have capacitances of between 10 nF and 900 nF.

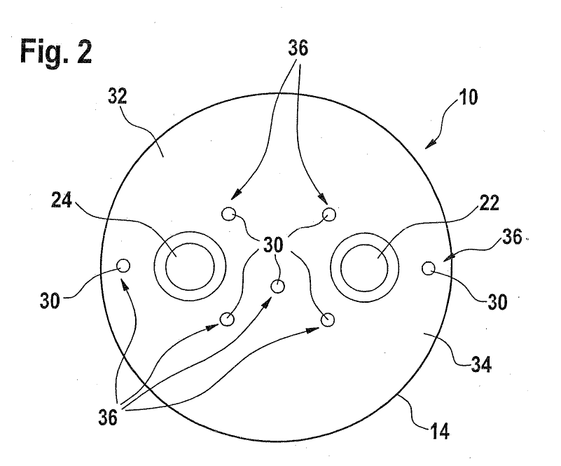

The ground terminals 20 of the capacitors 16 are connected by means of through-plated holes 30 to a ground face 34, shown in FIG. 2 and located on a further side 32 of the printed circuit board 14; the further side 32 describes the back or underside of the printed circuit board 14. The ground face 34 can be embodied over the full surface; that is, it can cover the entire further side 32 of the printed circuit board 14. However, it is also conceivable for the ground face 34 to cover only part of the further side 32, if structural provisions for instance require that. In any case, the ground face 34 should be designed such that it includes all the through-plated holes 30.

The through-plated holes 30 are preferably embodied as so-called via-holes 36. These are electrically conductive sleeves which in turn are filled with a highly conductive metal, such as copper, gold, or the like, in order to guarantee a very low-impedance and thus interference-free connection between the ground terminals 20 of the capacitors 16 and the ground face 34.

According to the invention, it is provided as shown in FIG. 1 that one varistor 38 each on the first side 12 of the printed circuit board 14 is connected via further conductor tracks 42 to the first terminal 22 and the at least one further terminal 24, respectively. A contact of both varistors 38 also exists with the common ground terminal 20. Alternatively, however, it is possible for each varistor 38 to have its own ground terminal 20. A Cx capacitor 40 is also shown, which is connected via the conductor tracks 42 to the first terminal 22 and to the at least one further terminal 24. Instead of only one Cx capacitor 40, a plurality of Cx capacitors 40 connected in series or in parallel may also be employed. This depends in particular on the power requirements made of the interference suppressor 10 and of the electrical motor 26. It is equally possible for a plurality of varistors 38 to be used for the first terminal 22 and for the at least one further terminal 24, respectively. The additional use of varistors 38 and Cx capacitors 40 makes a highly optimized-impedance connection of the interference suppressor 10 possible, with the varistors 38 serving to meet so-called load dump requirements or as shutoff voltage pulse limitation and the Cx capacitors 40 serving to meet long-, medium- or short-wave interference suppression requirements. Advantageously, the conductor tracks 18 and 42 and the ground face 34 and the ground terminals 20 are all embodied as copper layers. Alternatively, however, other electrically conductive materials may be used instead. It should also be noted that the term Cx capacitor describes a capacitor which is connected between the first terminal 22 and the at least one further terminal 24 and accordingly has no direct connection with the ground terminals 20. Like the capacitors 16, the at least one varistor 38 and/or the at least one Cx capacitor 40 may be embodied by SMD technology. As an alternative, contacting via radial or axial connection wires extended to the outside can also be considered. The capacitances of the at least one Cx capacitor 40, like those of the capacitors 16, can be in a range from 10 nF to 900 nF.

To protect the interference suppressor 10 against a possible short circuit, the conductor tracks 18 and 42, at defined points 44, have tapered portions 46, which burn through in the event of a short circuit and thus prevent the danger of fire caused by overheating. The tapered portions 46 may be implemented for instance by the fail-safe technology developed by the company known as Spectrum Control Inc.

For better suppression of the interference emissions, the conductor tracks 18 and 42 are located symmetrically about an axis 47 of the printed circuit board 14. It is not absolutely necessary for the axis 47 to pass—as shown in the exemplary embodiment—through the center point of the printed circuit board 14. Instead, the axis may also be a secant, or in the case where the printed circuit board 14 is other than round, the axis can be a straight line that intersects the printed circuit board 14 arbitrarily.

In FIG. 3, an exemplary embodiment of an electrical connection between the interference suppressor 10 of the invention and the direct current motor 26 is shown. The first side 12 of the printed circuit board 14 of FIG. 1 equipped with the capacitors 16, the varistors 38 and the Cx capacitor 40 can be seen. The first terminal 22 on the first side 12 of the printed circuit board 14 is put in contact with a first connection line 48 for a first stage of the direct current motor 24, and the connection line 48 as in FIG. 2 is fed through on the first side 32 of the printed circuit board 14 in insulated fashion relative to the ground face 34. Corresponding contacting exists between a further connection line 50 for a second stage of the direct current motor 24 and the further terminal 24. In this way, a continuous connection from a first supply potential V₊₁ and a second supply potential V₊₂ to the direct current motor 26 is possible.

The ground face 34 on the further side 32 of the printed circuit board 14 is connected electrically conductively via a contact point 52—for instance through a soldered connection—to a housing 54 that shields the interference suppressor 10. The shielding housing 54 can either be made entirely of metal or it can be made of a metal-sputtered plastic and is connected to a motor housing 58 of the direct current motor 26 via a plurality of contact points 56. In this respect, between eight and ten spring contacts 60 have proved to be a suitable a ground connection, and depending on the available space, it is entirely possible for fewer contact points 56 or more of them to be considered. Finally, via a ground line 62, there is also a direct connection between a reference potential V₋, the shielding housing 54, and the direct current motor 26. Alternatively, a connection of the ground line 62 with the shielding housing 54 can be dispensed with.

In FIG. 4, a block circuit diagram of the interference suppressor 10 of the invention is shown. The various parallel circuits of the capacitors 16 for the first and second stages of the direct current motor 26 (in the exemplary embodiment shown in FIGS. 1 and 3, four capacitors 16 per stage of the direct current motor 26) between the first terminal 22 and the further terminal 24 and the ground terminals 20. Via the first conductor tracks 18, the respective terminals 22 and 24, and the respective connection lines 48 and 50, each parallel circuit is connected not only to the first reference potential V₊₁, for the first stage of the direct current motor 26 and to the second supply potential V₊₂ for the second stage of the direct current motor 26, but also to the corresponding terminals of the direct current motor 26. Via the further conductor tracks 42, one varistor 38 is also connected between the first terminal 22 and the further terminal 24, respectively, and the ground terminals 20, while the Cx capacitor 40 provides for interference suppression between the first terminal 22 and the further terminal 24. Finally, via the ground line 62, there is an electrical connection between the direct current motor 26, the ground terminals 20, and the reference potential V₋. The shielding housing 54 is furthermore connected to the ground line 62 via the contact point 52. Finally, the failsafe short-circuit guard as described above is symbolized by reference numeral 64, and individual conductor tracks 18 and 42 may also be excluded from a short-circuit guard.

In conclusion, it should also be pointed out that the exemplary embodiment shown is not limited either to FIGS. 1 through 4 nor to the structure as shown of the conductor tracks 18 and 42 and of the ground terminals 20, nor to the capacitances stated for the capacitors 16 and the at least one Cx capacitor 40. The round shape of the printed circuit board as shown must not be understood to be a limitation, either. On the contrary, other shapes of printed circuit board (oval, polygonal, and so forth) may also be employed, in accordance with the given structural conditions and space available. The invention can also be employed in direct current motors with a plurality of directions; then the ground line 62 is either not connected, or is connected by means of a switching means not shown, to the particular connection line 48 or 50 of the direct current motor 26 that is at reference potential V₋.

It will be understood that each of the elements described above, or two or more together, may also find a useful application in other types of constructions differing from the types described above.

While the invention has been illustrated and described as embodied in a interference suppressor for suppressing high-frequency interference emissions from a direct current motor that is drivable in a plurality of stages and/or directions, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An interference suppressor (10) for suppressing high-frequency interference emissions of a direct current motor (26) that is drivable in a plurality of stages and/or directions, comprising a plurality of capacitors (16) located on a first side (12) of a printed circuit board (14), a plurality of first conductor tracks (18) located on the first side (12) of the printed circuit board (14) for putting the capacitors (16) into contact with a ground terminal (20), a first terminal (22) and at least one further terminal (24) provided for individual stages of the direct current motor (26), and put into contact with a first connection line (48) for a first stage and at least one second connection line (50) for at least one second stage of the direct current motor (26), a ground face (34) located on a second side (32), diametrically opposite the first side (12) of the printed circuit board (14), with the first connection line (48) and the at least one second connection line (50) fed through in insulated fashion relative to the ground face (34) wherein the ground face (34) is electrically connected via through-plated holes (30) embodied as via-holes (36) to the ground terminals (20) of the capacitors (16) on the first side (12) of the printed circuit board (14), and wherein the capacitors (16) are arranged in at least one group, in which the capacitors (16) are located in a C-shaped arrangement.

2. An interference suppressor (10) as defined in claim 1, wherein the capacitors (16) are arranged in two groups so that in each of the groups the capacitors are arranged in a C-shaped arrangement and surround a respective one of the first terminal (22) and the further terminal (24).

3. The interference suppressor (10) as defined in claim 2, wherein the capacitors (16) of one of the groups surround one of the terminals (22) while the capacitors (16) of the other of the groups surround the other of the terminals (24) so that interiors of the C-shaped arrangements of the capacitors (16) face each other.

4. The interferences suppressor (10) as defined in claim 2, wherein each of the groups of the capacitors (16) includes four capacitors (16), wherein the wire-holes (36) are located at open ends of each of the C-shaped arrangements of the capacitors (16) and at an apex point of each of the C-shaped arrangements of the capacitors (16).

5. The interferences suppressor (10) as defined in claim 1, wherein the wire-holes (36) are electrically conductive sleeves which are filled with a highly-conductive metal.
